(19) United States
(12) Patent Application Publication
(10) Pub. No.: US 2009/0154319 A1
(43) Pub. Date: Jun. 18, 2009

(54) OPTICAL DISC READING APPARATUS AND METHOD THEREFORE

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/300,646

(22) PCT Filed: May 8, 2007
(86) PCT No.: PCT/IB2007/051711

§ 371 Date: Nov. 13, 2008

(30) Foreign Application Priority Data
May 15, 2006 (EP) 06113930.9

(51) Int. Cl. G11B 20/18

(52) U.S. Cl. 369/53.35; G9B/20.046

(57) ABSTRACT

An optical disc reading apparatus, such as a Near Filed optical disc reading apparatus, comprises a disc reader (401) which generates a first signal by reading an optical disc (403). A bit detector (407) detects data values in response to the first signal. The detected data is fed to an error correction processor (407) which performs error correction on the stream of detected data. In addition, the reading apparatus comprises an error signal processor (411) which generates a reading head position error signal. The error signal may for example be indicative of an air gap error or a tracking error for the reading lens. The error signal is fed to a reliability processor (413) which sets reliability values of at least some of the detected data in response to the head position error signal. The error correction performed by the error correcting processor (407) then performs the error correction taking the reliability values into account. The invention may allow improved error correction performance.

The invention relates to an optical disc reading apparatus and method of operation therefor and in particular, but not exclusively, to a Near Field optical disc reading apparatus.

Optical disc storage has proved to be an efficient, practical and reliable method of storing and distributing data as is evidenced by the popularity of storage disc formats such as Compact Discs (CDs) and Digital Versatile Discs (DVDs).

Continued research is undertaken to find ways to increase the capacity of optical discs and especially research and development continuously strives to provide higher data densities thereby allowing a higher capacity for a given sized disc.

One of the problems in increasing capacity is that the maximum data density that can be recorded on an optical disk in an optical recording system inversely scales with the size of the laser spot that is focused onto the disk. The spot size is determined by the ratio of two optical parameters: the wavelength λ of the laser and the Numerical Aperture (NA) of the objective lens. In conventional optics, this NA is limited to values smaller than 1.0. In so-called Near-Field systems, the NA can be made larger than 1.0 by applying a Solid Immersion Lens (SIL), thus allowing a further extension to larger storage densities. It is important to note that this NA>1 is only present within an extremely short distance (the so called Near-Field) from the exit surface of the SIL, typically smaller than 1/10^{th} of the wavelength of the light. This means that during writing or read-out of an optical disk, the distance between the SIL and disk must at all times be smaller than a few tens of nanometres. This distance is referred to as the air gap.

To allow accurate air gap control with a mechanical actuator at such small distances, a suitable error signal is required. As proposed in F. Zijp and Y. V. Martynov, “Optical Storage and Optical information processing”, Han-Ping D. Shieh, Tom D. Milster, Editors, Proceedings of Society of Photo-Optical Instrumentation Engineers Vol. 4081 (2000) pp. 21-27; (the International Society for Optical Engineering, Bellingham, Wash., 2000), ISSN 0277-786X/00; ISBN 0-8194-3720-4 and demonstrated in for example F. Zijp, M. B. van der Mark, J. I. Lee, C. A. Verschuren, B. H. W. Hendriks, M. L. M. Balistreri, H. P. Urbach, M. A. H. van der Aa, A. V. Padiy, “Optical Data Storage 2004”, edited by B. V. K. Vijaya Kumar, Hiromichi Kobori, Proceedings of Society of Photo-Optical Instrumentation Engineers Vol. 5380 (2004) pp. 209-223; (the International Society for Optical Engineering, Bellingham, Wash., 2004); ISSN 0277-786X/04, a good gap error signal (GES) is obtained from the reflected light with a polarization state perpendicular to that of the main beam that is focused on the disc. A significant fraction of the light becomes elliptically polarized after reflection at the SIL-air-disk interfaces: this creates a well-known Maltese cross effect when the reflected light is observed through a polarizer. The GES is generated by integrating all the light of this Maltese cross using polarizing optics and a single photo-detector.

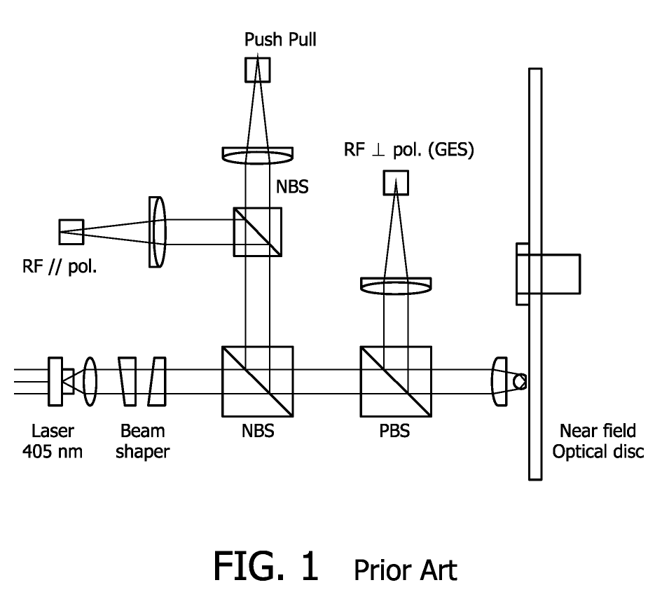

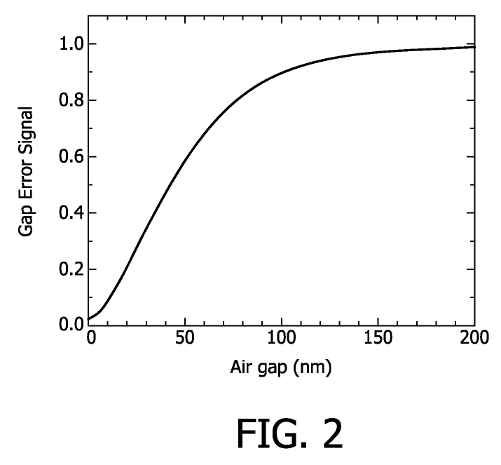

FIG. 1 illustrates an example of a Near-Field optical disc reader in accordance with prior art (PBS=polarizing beam splitter; NBS=non-polarizing beam splitter). FIG. 2 illustrates a calculated GES curve as a function of the air gap for an NA=1.9 lens and an optical disc with a phase change recording stack.

Even small changes in the air gap (say 1-5 nm) have a direct and significant impact on the spot intensity and quality, and therefore decrease the bit detection performance significantly. This is quite different from the conventional far-field optics, where the dominant aberration is defocus. Due to the relatively small NA, the effect of small changes in the lens-to-disc distance, i.e. focus errors, is not important in this case. In near-field optics, the spot shape is determined by the efficiency of the evanescent coupling, as well as by significant polarization induced effects. These phenomena are strongly non-linear, but can be calculated for a given system configuration.

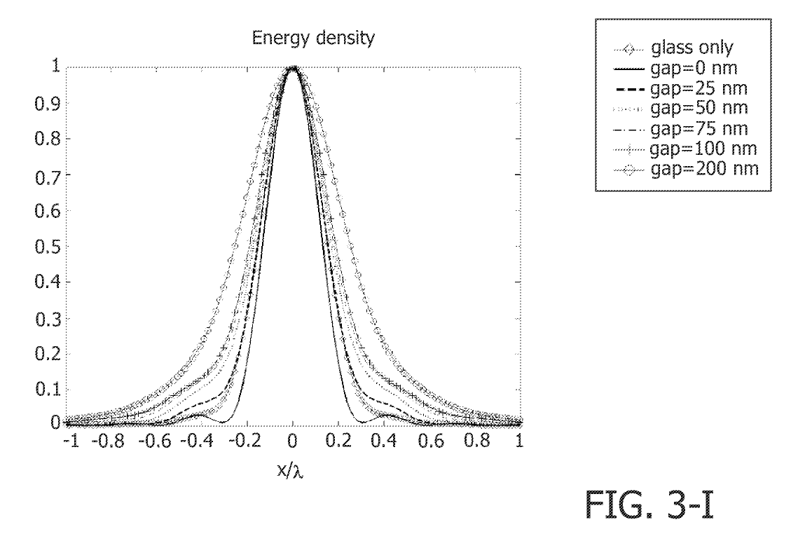

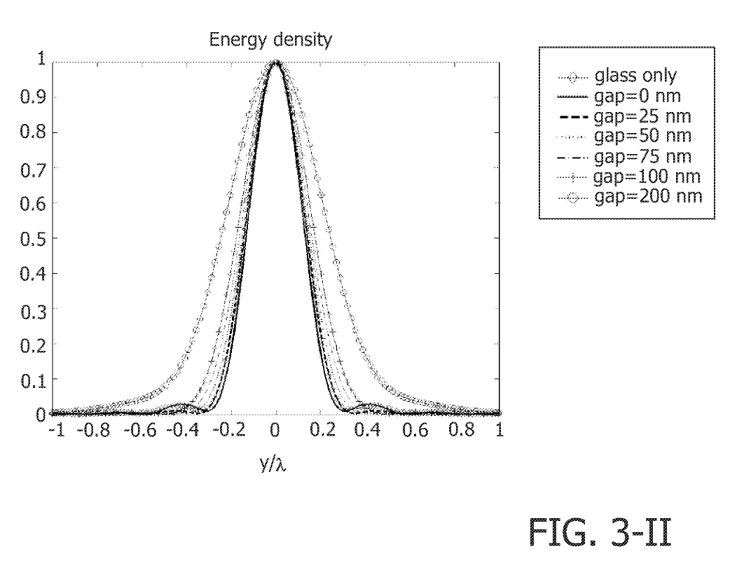

Thus, in such systems, residual air gap errors, e.g. occurring at high rotation speeds of the disc (to achieve a high data rate) have a strong effect on the properties of the optical spot. In most cases (but not always), the effect is negative (broader spot, larger aberrations) for increases in the air gap, and positive (narrower spot, smaller aberrations) for decreases in the air gap. FIG. 3 illustrates an example of the shape of a data spot as a function of the air gap and as can be seen the inter-symbol interference will substantially depend on the air gap. Generally, the effect of the variations is that an increased number of errors are generated by the bit detector of the optical disc readers. Typically, error correction circuits (ECC) and methods are included which may substantially reduce the number of errors using some additional data on the disc.

However, an increased error rate may result and in particular if air gap variations are larger than a certain amount, the bit detection circuit will yield a lot of erroneous data which the ECC may not be able to correct, leading to partial data loss. This is especially the case when the air gap variation is fast and abrupt, so that adaptive measures in the detection circuit cannot compensate in time.

Similarly, tracking errors may introduce substantial interference from neighbouring data tracks on the optical disc which may result in a substantially increased error rate of the detected data. Furthermore, for sufficiently large tracking errors such errors cannot be compensated by the ECC.

Thus, conventional optical disc reading systems tend to have an undesirable sensitivity to errors and variations in the positioning of the reading lens. Such effects can for example occur due to external shocks during operation of the optical disc system, physical defects or due to contamination on the disc.

Hence, an improved optical disc reading would be advantageous and in particular an approach allowing reduced error rates, improved adaptation, facilitated implementation and/or improved performance would be advantageous.

Accordingly, the Invention seeks to preferably mitigate, alleviate or eliminate one or more of the above mentioned disadvantages singly or in any combination.

According to a first aspect of the invention there is provided an optical disc reading apparatus comprising: a disc reader for generating a first signal by reading an optical disc; a bit detector for generating a stream of detected data in response to the first signal; error correcting means for performing error correction on the stream of detected data; error signal means for generating a reading head position error signal; and means for setting reliability values of at least some of the detected data in response to the head position error signal; and wherein the error correcting means is arranged to perform the error correction in response to the reliability values.

The invention may allow an improved optical disc reading apparatus. An improved error correction of data read from the optical disc may be achieved and in particular the error rate of the generated output data may be reduced. The invention may allow a low complexity implementation with improved performance. The invention may specifically allow a fast adaptation of error correcting operations to the dynamic physical conditions.

The reading head position error signal may be indicative of a position of a reading element of the optical disc reader such as a lens for receiving the optical beam from the optical disc. Specifically, the reading head position error signal may be indicative of a position of a Solid Immersion Lens (SIL). The reading head position error signal may be an absolute value indicative of an absolute head position or a head position relative to e.g. a nominal position. The reading head position error signal may be indicative of a position of a reading element in one or more dimensions.

According to an optional feature of the invention, the reading head position error signal is a head gap error signal

The invention may allow improved performance by allowing the error correction operation to be dependent on the variations in the gap between a reading element and the optical disc. The invention may in particular allow fast variations in the gap to be taken into account by the error correction. The head gap error signal may be indicative of a distance between the surface of the optical disc and the reading element and may specifically be indicative of the air gap substantially perpendicular to the plane of the optical disc.

According to an optional feature of the invention, the error signal means is arranged to determine the head gap error signal in response to a measure of reflected light from the optical disc having a different polarity direction than a main beam.

This may allow improved error correction and/or facilitated implementation.

According to an optional feature of the invention, the means for setting reliability values is arranged to indicate detected data values as erasure values if the reading head position error signal exceeds a threshold.

This may allow improved error correction and/or facilitated implementation. The erasure value may be a value indicating that the data value is detected as unknown.

According to an optional feature of the invention, the head position error signal is a relative signal indicative of a deviation from a nominal value.

This may allow improved error correction and/or facilitated implementation.

According to an optional feature of the invention, the reading head position error signal is an indication of a head position tracking error relative to a data track of the optical disc.

The invention may allow improved performance by allowing the error correction operation to be dependent on the variations in the lateral tracking performance. The invention may in particular allow fast variations in the tracking to be taken into account by the error correction. The head position tracking error may be indicative of a deviation of the reading element from directly above the circular/spiral data track along which the optical data spots are written on the optical disc. The head position tracking error may be indicative of a reading element position along a plane substantially parallel to the plane of the optical disc.

According to an optional feature of the invention, the bit detector is arranged to perform a Partial Response Maximum Likelihood, PRML, bit detection.

This may allow improved error correction and/or facilitated implementation.

According to an optional feature of the invention, the error correcting means is arranged to execute a Reed Solomon data correction algorithm.

This may allow improved error correction and/or facilitated implementation.

According to an optional feature of the invention, the optical disc reading apparatus is a Near Field optical disc reading apparatus.

The invention may allow an improved performance of a Near Field optical disc reading apparatus.

According to another aspect of the invention, there is provided a method of operation for an optical disc reading apparatus, the method comprising: generating a first signal by reading an optical disc; generating a stream of detected data in response to the first signal; performing error correction on the stream of detected data; generating a reading head position error signal; and setting reliability values of at least some of the detected data in response to the head position error signal; and wherein the error correction is performed in response to the reliability values.

These and other aspects, features and advantages of the invention will be apparent from and elucidated with reference to the embodiment(s) described hereinafter.

Embodiments of the invention will be described, by way of example only, with reference to the drawings, in which

FIG. 1 illustrates an example of a Near-Field optical disc reader in accordance with prior art;

FIG. 2 illustrates a calculated air gap error signal function of the air gap for Near-Field optical disc reader;

FIG. 3 illustrates an example of the shape of a data spot as a function of the air gap; and

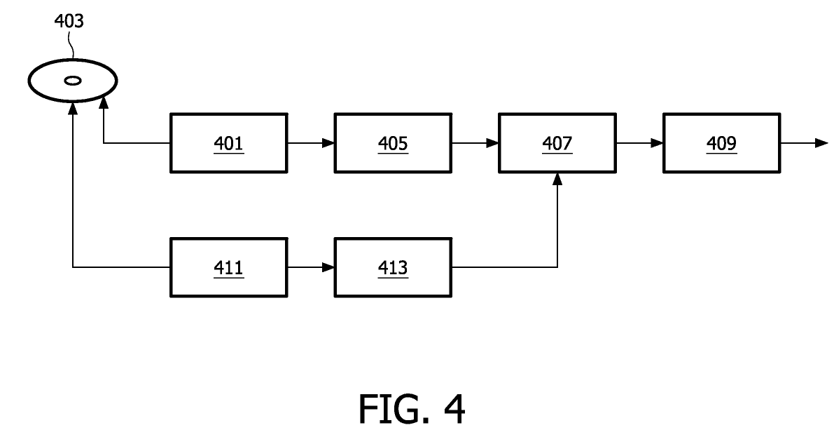

FIG. 4 illustrates an example of an optical disc reading apparatus in accordance with some embodiments of the invention.

The following description focuses on embodiments of the invention applicable to a Near Field optical disc reading apparatus. However, it will be appreciated that the invention is not limited to this application but may be applied to many other optical disc readers and systems.

FIG. 4 illustrates an example of an optical disc reading apparatus in accordance with some embodiments of the invention.

In the example, an optical disc data reader 401 reads data from an optical disc 403. The data stored on the optical disc 403 is RLL (Run Length Limited) coded. Furthermore, the optical disc data reader is a Near Field optical disc reader reading data from a high density optical disc 403. The optical disc data reader 401 specifically comprises a Solid Immersion Lens (SIL) which is controlled to be positioned very close to the surface of the disc. The reading head comprising the SIL is thus controlled such that the disc surface is within an extremely short distance (the so called Near-Field) from the exit surface of the SIL, typically smaller than 1/10^{th} of the wavelength of the light. Accordingly, the data is read with an NA>1 thereby allowing high data density on the disc. The data reader 401 generates an output signal which is a sampled representation of the analog signal read from the disc. Due to the inter-symbol interference introduced by the optical system, a given data sample comprises contributions from a plurality of data symbols surrounding the data sample.

The data samples read from the optical disc are fed from the optical disc data reader 401 to a bit detector 405 which is arranged to generate detected bit values corresponding to the data values stored on the optical disc 403. The bit detector 405 specifically comprises a Partial Response Maximum Likelihood (PRML) (or a Maximum Likelihood Sequence Estimator (MLSE)) detector which determines the detected values in response to reference signals corresponding to expected signal values for different possible data sequences as will be well known to the person skilled in the art. Accordingly, the bit detector 405 may specifically be a Viterbi bit detector.

The bit detector 405 is coupled to an error correction processor 407 and the detected data is fed to this. The error correction processor 407 performs additional error correction of the raw decoded data using redundant data of the optical disc. For example, for optical discs, the raw detected data from the bit detector 405 typically has a relatively high error rate and therefore a strong error correcting code is normally used. Thus, when the disc is written redundant data is added to the disc in accordance with a suitable error correcting coding scheme. When the data is read from the optical disc 403, an error correcting decoding operation is performed by error correction processor 407 in accordance with the selected error correcting coding scheme. Specifically, for optical disc systems a strong two-dimensional 8 bit based Reed-Solomon error correcting scheme is frequently used.

The error correction processor 407 is coupled to a data interface 409 which interfaces to external equipment. For example, the data interface 409 may provide an interface to a personal computer.

However, although optical disc reading systems apply high complexity and performance bit detection and error correction, the signal received from the optical disc may in some cases be so distorted that the original data cannot be decoded. For example, for near Field optical systems using a SIL, the quality of the signal depends strongly on maintaining an accurate distance between the surface of the optical disc and the SIL. A typical value for this distance is 30 nm. However, if the distance (often referred to as the air gap) deviates by more than a certain amount (typically around 5 nm), the optical spot quality deteriorates so much that bit-detection is no longer reliable. Furthermore, the deterioration is so significant that the error correction cannot correct all errors and thus erroneous data will be output.

It will be appreciated that the same effect can occur for other reasons. For example, if a lateral tracking of the SIL deviates sufficiently from the correct track alignment, the reading signal can deteriorate to the extent where reliable data detection cannot be achieved.

In the data reader of FIG. 4, the optical disc reading apparatus furthermore comprises an air gap processor 411 which is arranged to generate a reading head position error signal which is indicative of a position of the reading lens (the SIL) which is used to read the data from the optical disc. Specifically, the reading head position error signal can be indicative of a distance between a recording layer or surface of the optical disc and the SIL.

In the example, the air gap processor 411 comprises a sensor which is arranged to detect light reflected from the surface of the optical disc and having a different polarisation than the main beam. Specifically, the reflected light with a polarization state perpendicular to that of the main beam which is focused on the disc is detected and fed to a processing element of the air gap processor 411. An error signal is generated by integrating all the light of the Maltese cross pattern which results from the reflections of the disc when detected by using polarizing optics and a photo-detector. Specifically the air gap processor 411 can generate relative or absolute reading head position error signals.

For example, the error signal can directly indicate the amount of detected light which may be considered as a direct indication of the distance between the optical disc surface and the SIL. As another example, the error signal can indicate a deviation from a nominal distance between the optical disc surface and the SIL. E.g. the preferred air gap between the optical disc surface and the SIL may be 30 nm. The amount of light detected for this distance may be stored in the air gap processor 411 as a reference. The difference between the currently detected light and the reference value can then be determined and used as an indication of the deviation from the nominal distance.

The air gap processor 411 is coupled to a reliability processor 413 which is arranged to set reliability values for the detected data from the bit detector in response to the head position error signal.

The reliability processor 413 is coupled to the error correcting processor 407 which is fed the reliability information. The error correcting processor 407 is arranged to take this reliability information into account when decoding the data from the bit detector 405.

It will be appreciated that the reliability information may be provided as a separate signal to the detected data or may for example be merged with the detected data e.g. by directly modifying the detected data values from the bit detector 405 to reflect the reliability of the data.

For example, the bit detector may generate binary decoded data corresponding to the values 1 and −1. The reliability signal may be a continuous signal which indicates the current deviation from the nominal air gap. For example, when the air gap is at the nominal value, the reliability signal may have a value of 1 and when the air gap is so large that the data cannot be detected the reliability signal may have a value of 0. In this case, the decoded binary data values may be multiplied by the reliability signal to generate soft decision values where the amplitude of the soft decision data indicates the reliability of the data decision. The soft decision data values may then be used in the error correcting operation performed by the error correcting processor 407. It will be appreciated that any suitable algorithm for error correction based on soft decision values may be used without detracting from the invention.

As another example, the reliability processor 413 may compare the received air gap signal to a given threshold value indicative of an air gap deviation at which the detected data becomes unreliable. If the air gap signal exceeds the threshold, the corresponding data value is set as an erasure data value which is indicative of no decision being made for this data value. For example, in the previous binary detection example, the detected data value may be set to 0 when the air gap signal exceeds the predetermined threshold, (which may e.g. correspond to a deviation of the SIL of more than 5 nm from the nominal value).

Such an embodiment may allow a particularly low complexity implementation while providing significantly improved performance. Furthermore, the use of erasure values are particularly attractive for error correcting decoders like Reed Solomon decoders which provide particularly improved performance when provided with such reliability information.

The described approach may allow an improved error correction thereby providing a reduced error rate of the output data. Specifically, the approach may allow the optical reading system to provide reliable data for larger air gap variations than in conventional systems.

Thus, the optical disc reading apparatus of FIG. 4 provides for feeding side-information of the gap error signal deviations (residual air gap) into the error correction operation. Specifically, for large air gap deviations, the corresponding bits (or bytes: error correction processing is frequently byte based for optical discs) are marked as so-called erasures corresponding to unknown data values in the error correction. This may result in an improved byte error rate which is typically a factor of two better than conventional systems.

It will be appreciated that although the above description focused on providing side information relating to the air gap of a near field optical disc reading apparatus, the described approach may be used in many other applications.

For example, in some embodiments the optical disc reading apparatus can comprise a tracking error processor as an alternative or in addition to the air gap processor 411. The tracking error processor can be arranged to detect a deviation of the reading lens from the ideal position over the data track on the optical disc. The signal indicating the current tracking error can then be used to set the reliability of the detected data values from the bit detector 405. For example, if the tracking error rate exceeds a given value, the corresponding data values can be set as erasure values.

Thus, a tracking error signal (for example determined from a single spot push-pull, three spot tracking, differential phase or other methods) can be used as side-information for the error correction. When the residual error is larger than a predetermined threshold, e.g. 20% of the track pitch, the cross-talk from neighbouring tracks may be considered too large for reliable detection. Again, the corresponding bits/bytes are accordingly marked as erasures in the error correction processor thereby improving the error rate of the output data.

It should be noted that whereas the high sensitivity to the air gap variations mainly (but not exclusively) apply to near field systems with numerical apertures larger than 1.0, the tracking signal side-information may be equally beneficial in far field (numerical aperture<1.0) optical systems.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An optical disc reading apparatus comprising:
a disc reader (401) for generating a first signal by reading an optical disc (403);
a bit detector (405) for generating a stream of detected data in response to the first signal;
error correcting means (407) for performing error correction on the stream of detected data;
error signal means (411) for generating a reading head position error signal; and
means (413) for setting reliability values of at least some of the detected data in response to the head position error signal; and wherein
the error correcting means (407) is arranged to perform the error correction in response to the reliability values.

2. The optical disc reading apparatus of claim 1 wherein the reading head position error signal is a head gap error signal

3. The optical disc reading apparatus of claim 2 wherein the error signal means (411) is arranged to determine the head gap error signal in response to a measure of reflected light from the optical disc (403) having a different polarity direction than a main beam.

4. The optical disc reading apparatus of claim 1 wherein the means (413) for setting reliability values is arranged to indicate detected data values as erasure values if the reading head position error signal exceeds a threshold.

5. The optical disc reading apparatus of claim 1 wherein the head position error signal is a relative signal indicative of a deviation from a nominal value.

6. The optical disc reading apparatus of claim 1 wherein the reading head position error signal is an indication of a head position tracking error relative to a data track of the optical disc.

7. The optical disc reading apparatus of claim 1 wherein the bit detector (405) is arranged to perform a Partial Response Maximum Likelihood, PRML, bit detection.

8. The optical disc reading apparatus of claim 1 wherein the error correcting means (407) is arranged to execute a Reed Solomon data correction algorithm.

9. The optical disc reading apparatus of claim 1 wherein the optical disc reading apparatus is a Near Field optical disc reading apparatus.

10. A method of operation for an optical disc reading apparatus, the method comprising:
generating a first signal by reading an optical disc (403);
generating a stream of detected data in response to the first signal;
performing error correction on the stream of detected data;
generating a reading head position error signal; and
setting reliability values of at least some of the detected data in response to the head position error signal; and wherein
the error correction is performed in response to the reliability values.
